(19) United States
(12) Patent Application Publication
(10) Pub. No.: US 2011/0070072 A1
(43) Pub. Date: Mar. 24, 2011

(54) ROTARY MACHINE TIP CLEARANCE CONTROL MECHANISM

(75) Inventor: Moorthi Subramaniyan, Bangalore (IN)

(73) Assignee: General Electric Company

(21) Appl. No.: 12/565,108

(22) Filed: Sep. 23, 2009

(51) Int. Cl. F01D 11/14; B23P 11/00

(52) U.S. Cl. 415/173.2; 29/889.2

(57) ABSTRACT

A tip clearance control mechanism for a rotary machine adapted for reducing leakage flows, and minimizing tip vortex size and penetration into main flow that will improve turbine efficiency. The tip clearance control mechanism includes inventive arrangements of a rotating shroud and a shape of the shroud, teeth of various shapes and locations on the rotating shroud, and one or more stator teeth of various shapes and locations on a stationary shroud or casing wall configurations providing comparable tip clearance control. The reduction in leakage flow is a function of how these components are assembled together, which defines a clearance passage between the rotating shroud and the stationary shroud.

### BACKGROUND OF THE INVENTION

The invention relates generally to turbine engines and more specifically to a tip clearance control mechanism for turbine blades of the turbine engines.

A turbine stage consists of a row of stationary vanes followed by a row of rotating blades in an annulus. The flow is partially expanded in the vanes and directs it to the rotating blades, where it is further expanded to generate required power output. For the safe mechanical operation, there exists a minimum physical clearance requirement between the tip of the rotating blade and outer annulus wall of the casing of the turbine engine. This clearance varies based on the rotor dynamic and thermal behaviors of the rotor and casing. Reduction in physical clearance will lead to reliability issues.

Turbine blades are rotating airfoil-shaped components in series of stages designed to convert thermal energy from a working fluid, such as gas or steam, into mechanical work of turning a rotor. The high-energy flow leaving through clearance area will account for 20% loss in the stage performance and thus reduction in power output. Performance of a turbine can be enhanced by sealing the outer edge of the blade tip to prevent the working fluid from escaping the working flowpath into the gaps between a blade tip and an outer casing of turbine. A common manner for sealing the gap between the turbine blade tips and the turbine casing is through blade tip shrouds. Not only do shrouds enhance turbine performance, but also serve as a vibration damper, especially for large, radial-length turbine blades. The shroud acts as a mechanism to raise the blade natural frequency and in turn minimizes failures due to extended resonance time of the blade at a natural frequency.

A portion of a typical turbine blade with a shroud (also referred to as turbine bucket cover or tip cover) is shown in FIG. 1. The turbine blade 10 includes an airfoil section 11 and shroud 12. The shroud 12 may be manufactured integral to the airfoil 11. The airfoil further contains a leading edge 15 and trailing edge 16 that run generally perpendicular to shroud 12. The shroud 12 has a thickness and has sidewalk 17, which may be cut to create an interlocking configuration when adjacent turbine blades are present. The interlocking mechanism occurs along two bearing faces 13, where adjacent turbine blades (not shown) contact at shroud 12. It is the interlocking of the turbine blade shrouds 12 at bearing faces 13, that creates means for damping out vibrations, as well as for sealing the working fluid within the turbine gas-path. An additional feature of a typical turbine blade shroud may be a knife-edge tip seal (also known as rotor tooth or tooth seal) 14. Depending upon the size of the blade shroud, one or more tip seals may be utilized. These seals run parallel to each other, typically perpendicular to the engine axis 18, and extend outward from shroud 12. The purpose of these seals is to engage the shroud blocks of the turbine casing (not shown) to further minimize leakage around the blade tip and reduce mechanical impact in case the bucket tip rubs the casing. Tip leakage diverts working fluid that would otherwise flow in a main flow path and perform work on the turbine blades. Tip leakage may further result in elevated tip vortex size and intensity, which may penetrate the main steam flow path downstream from the blade, raising backpressure and thereby lowering the efficiency of the stage. However, a clearance between the tip seal and the casing shroud needs to be provided to account for thermal expansion and asymmetry of rotation. A fully covered turbine blade tip has better aerodynamics performance over uncovered bucket tip because of reduced tip vortex size, intensity, and tip leakage.

While the purpose of the shroud is to seal the working fluid within the flow path as well as to provide a means to dampen vibrations, the shroud has its disadvantages as well. A drawback to the shroud concept is the weight the shroud adds to the turbine blade. During operation, the turbine blades spin on a disk, about the engine axis. A typical industrial application includes disk speeds up to 3600 revolutions per minute. The blades are held in the disk by an interlocking cut-out between the blade root and the disk. As the turbine blade spins, the centrifugal forces cause the blade to load outward on the turbine disk at this attachment point. The amount of loading on the disk and hence the blade root, which holds the blade in the disk, is a function of the blade weight. That is, the heavier the blade, the more load and stresses are found on the interface between the blade root and disk, for a given revolutions per minute. Excessive loading on the blade root and disk can reduce the overall life of each component. Another drawback to shrouds is creep curling of the blade shrouds. Depending on the thickness of the shroud, the shroud edges can “curl” up at their ends and introduce severe bending stresses in the fillets between the shroud and blade tip. Shrouds curl due to the bending load on the edges of the shroud from gas pressure loads as well as centrifugal loads. The curling of a shroud is analogous to the bending of a cantilevered beam due to a load at the free end of the beam. An industry known fix to this curling phenomenon is to increase the section thickness of the shroud uniformly which will result in a stiffer shroud and more resistance to curling. The downside to simply increasing the shroud thickness uniformly is the additional weight that is added to the shroud by this additional material.

As described above, to prevent the tip cover from rubbing turbine casing wall and to further reduce tip leakage, one or several seal teeth can be placed on the top of a tip cover. In some applications, rotor teeth can be accompanied by stator teeth suspended from a casing shroud and integrated with the rotor teeth.

Accordingly, it would be desirable to limit tip leakage for turbine blades, while at the same time providing enhanced stage efficiency.

### BRIEF DESCRIPTION OF THE INVENTION

According to a first aspect of the present invention, a rotary machine tip clearance control mechanism for a stage of a low pressure steam turbine is provided. The clearance mechanism provides a rotor blade including an airfoil with a rotor blade shroud disposed on an outer radial tip of the airfoil. A rotor tooth projects radially outward on the rotor blade shroud, with the rotor tooth being generally centered with respect to an axial chord of the airfoil. A casing shroud may be disposed radially outward from the rotor blade shroud. At least one stator tooth is provided on the casing shroud. The stator tooth may project inward radially and be disposed axially relative to the rotor tooth. A clearance area may be formed between the rotor blade shroud and the casing shroud, the clearance area being adapted to limit leakage flow and increase stage efficiency.

A further aspect of the present invention provides a method for providing a tip clearance control mechanism for rotor blade of a stage of a low pressure steam turbine between a rotor blade shroud of a rotor blade and a casing shroud. The method includes selecting a shape for a tip shroud; selecting a rotor tooth shape; selecting a number of rotor teeth; selecting a stator tooth shape; and selecting a number of stator teeth.

### BRIEF DESCRIPTION OF THE DRAWING

These and other features, aspects, and advantages of the present invention will become better understood when the following detailed description is read with reference to the accompanying drawings in which like characters represent like parts throughout the drawings, wherein:

FIG. 1 illustrates a prior art shroud for a turbine blade;

FIG. 2A illustrates a plurality of arrangements of rotor tip shroud configurations with variations in the number and arrangement of stator teeth and number and arrangement of rotor teeth;

FIG. 2B illustrates a plurality of stator tooth structures;

FIG. 2C illustrates a plurality of rotor tooth structures;

FIG. 2D illustrates various exemplary tip clearance control configurations wherein stator teeth may be formed as an integral part of the casing.

FIG. 3 illustrates a turbine blade incorporating an inventive clearance mechanism on a rotor blade shroud;

FIG. 4A illustrates geometric parameters for components of a rotor shroud and casing shroud for an inventive tip clearance control mechanism;

FIG. 4B illustrates a top view of a top surface of a rotor blade shroud for a large blade of a low pressure steam turbine;

FIG. 5A illustrates leakage flow past a single conventional rotor tooth disposed at a typical location on an aft end of a rotor blade shroud;

FIG. 5B illustrates leakage flow control for a preferred embodiment of the clearance mechanism on a last stage blade for a low pressure turbine;

FIG. 6A illustrates leakage flow past a single conventional rotor tooth disposed at a typical location on an aft end of a rotor blade shroud for a next-to-last stage of a low pressure turbine;

FIG. 6B illustrates leakage flow for the preferred embodiment of the clearance mechanism for a next-to-last stage of a low pressure turbine; and

FIG. 7 illustrates a flowchart for the method 500 for forming a clearance mechanism for the rotor blade of low pressure steam turbine.

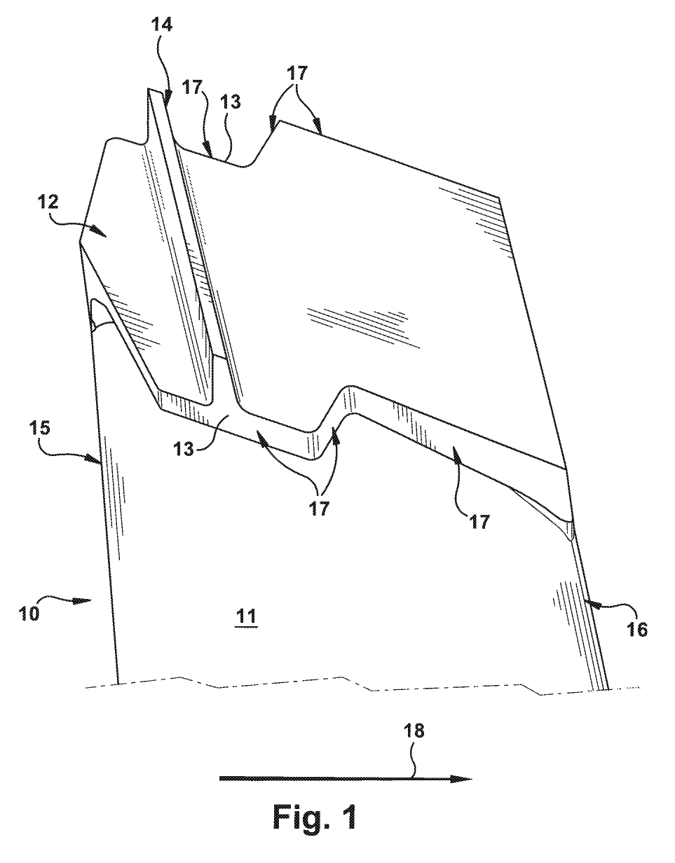

### DETAILED DESCRIPTION OF THE INVENTION

The following embodiments of the present invention have many advantages, including reducing bucket tip leakage flow, increasing rotor torque work, minimizing mixing losses caused by tip vortex, improving turbine performance and reducing tip cover weight.

The present invention relates to a rotary machine with a tip clearance control mechanism for reducing leakage flows, minimizing tip vortex size and penetration into main flow that will improve turbine efficiency. The tip clearance control mechanism includes inventive arrangements of a rotating shroud and a shape of the shroud, teeth of various shapes and locations on the rotating shroud, and one or more teeth of various shapes and locations on a stationary shroud or casing wall configurations providing comparable tip clearance control. The reduction in leakage flow is a function of how these components are assembled together, which defines a clearance passage between the rotating shroud and the stationary shroud.

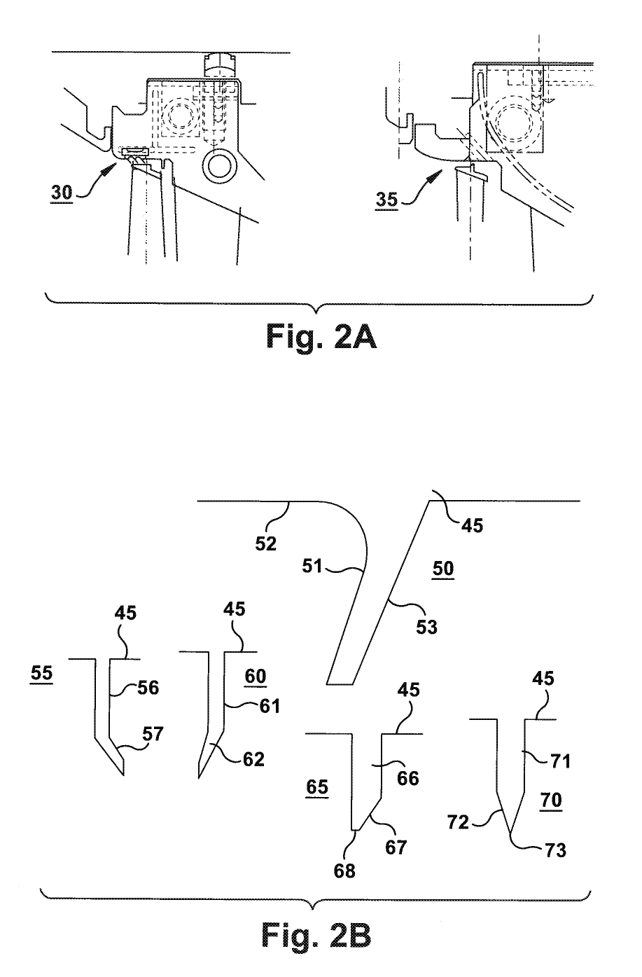

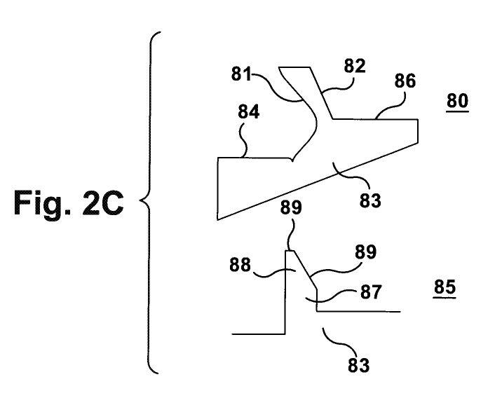

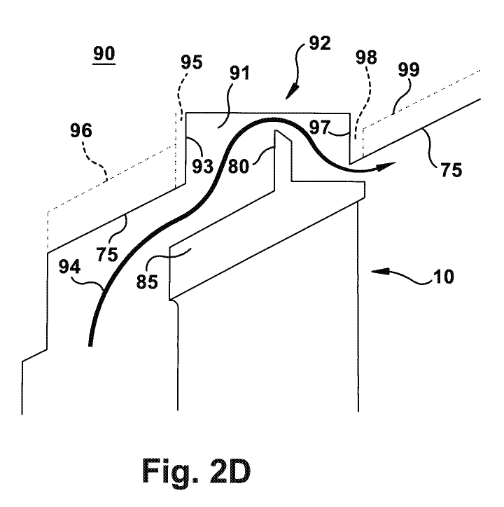

FIGS. 2A, 2B 2C and 2D illustrate a variety of exemplary inventive arrangements that may be considered for establishing an inventive tip clearance control mechanism for a rotary machine.

FIG. 2A illustrates a plurality of exemplary inventive arrangements 30, 35 of rotor tip shroud configurations with variations in the number and arrangement of stator teeth and number and arrangement of rotor teeth. The rotor tip shroud arrangements may include a top surface with a slope on the upstream side mating with a generally level downstream side. The rotor tip shroud may include a top surface with a slope on the upstream side with a generally level downstream side separated by a step.

FIG. 2B illustrates a plurality of exemplary inventive stator tooth structures. The stator tooth 50 includes extends into the clearance passage in a generally upstream direction with respect to leakage flow. The upsteam surface 51 of the stator tooth 50 may be contoured to smoothly blend into the upsteam surface 52 of the stationary shroud 45. The downsteam surface 53 may be flat. Stator tooth 55 may include a first section 56 of roughly constant thickness extending into the clearance passage normal to the stationary shroud 45 and a generally tapered section 57 extending further into the clearance passage in a downstream direction with respect to the leakage flow. Stator tooth 60 may include a first section 61 of roughly constant thickness extending into the clearance passage normal to the stationary shroud 45 and a generally tapered section 62 extending further into the into the clearance passage in an upstream direction with respect to the leakage flow. Stator tooth 65 may include a first section 66 of roughly constant thickness extending into the clearance passage normal to the stationary shroud 45 and a tapered section 67 extending further normal into the clearance passage, the taper provided on the downstream side with respect to leakage flow. A top surface 68 may be provided on stator tooth 67. Stator tooth 70 may include a first section 71 of constant thickness extending into the clearance passage with a second section 72 extending from the first section and tapering on both sides to an edge 73.

FIG. 2C illustrates a plurality of exemplary inventive rotor tooth structures. Rotor tooth 80 may include a generally curved upstream surface 81 and a generally flat downstream surface 82 with respect to leakage flow. The rotor tooth 80 may extend into the clearance passage in a generally upstream direction with respect to the leakage flow. Rotor tooth 80 may extend from a first surface 84 on the upsteam side of the rotor shroud 83 and from a downstream surface 86 of a different elevation on the rotor shroud 83. Rotor tooth 85 may extend normal to the rotor shroud 83 into the clearance passage. Rotor tooth 85 may include a first section 87 with constant thickness and an outer section 88 with tapered thickness, wherein the taper is provided on the downstream side 89 with respect to the leakage flow, terminating at top surface 89.

FIG. 2D illustrates various exemplary tip clearance control configurations of casing options 90 wherein stator teeth may be formed as an integral part of a casing for a rotary machine. A rotor blade 10 with a rotor tip shroud 85 may include one or more rotor teeth 80 within a trenched area 91 of a casing 92 for a rotary machine. An inner wall 75 of the casing 92 may define an outer boundary for leakage flow 94 past the rotor tip. Depending on the physical configuration of the casing, either stator tooth may be physically formed or the step in the casing may provide an obstruction to leakage flow in lieu of the discrete stator tooth. As an example, a relative height of the steps of the trench 91 of the casing 92 may itself provide the clearance control in conjunction with the rotor teeth (tooth) 80. In FIG. 2D, the first step 93 of the trench 91 may provide a first resistance to leakage flow 94, functionally replicating a first stator tooth 95 forward relative to the rotor tooth 80 within casing wall layout 96. The second step 97 of the trench 91 may act as a resistance replicating a second stator tooth 98 aft relative to the rotor tooth 80, wherein the discrete second stator tooth would be formed with a recessed casing wall 99.

In the present invention, a rotating blade may include a shroud along with teeth, which is placed in between a set of stationary teeth located on a shroud attached at the casing wall of the turbine. When the flow passes through the clearance passage, vortices are formed, which reduce the effective clearance and lead to reduced clearance flow.

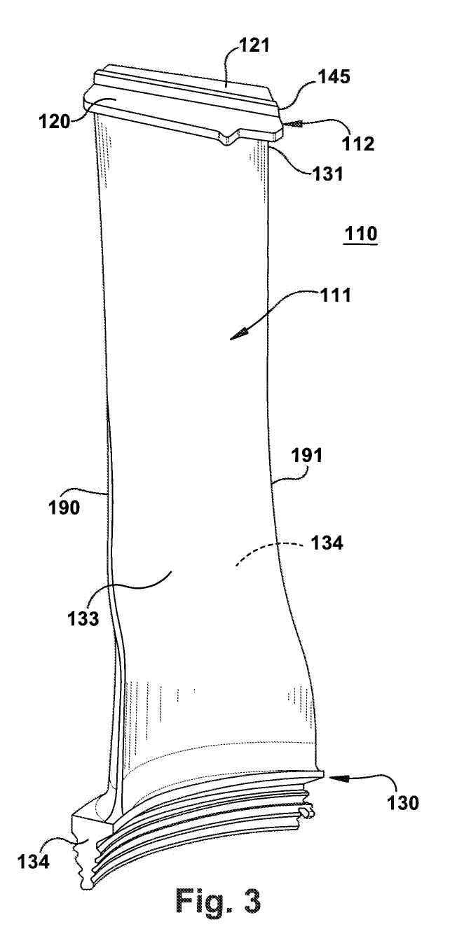

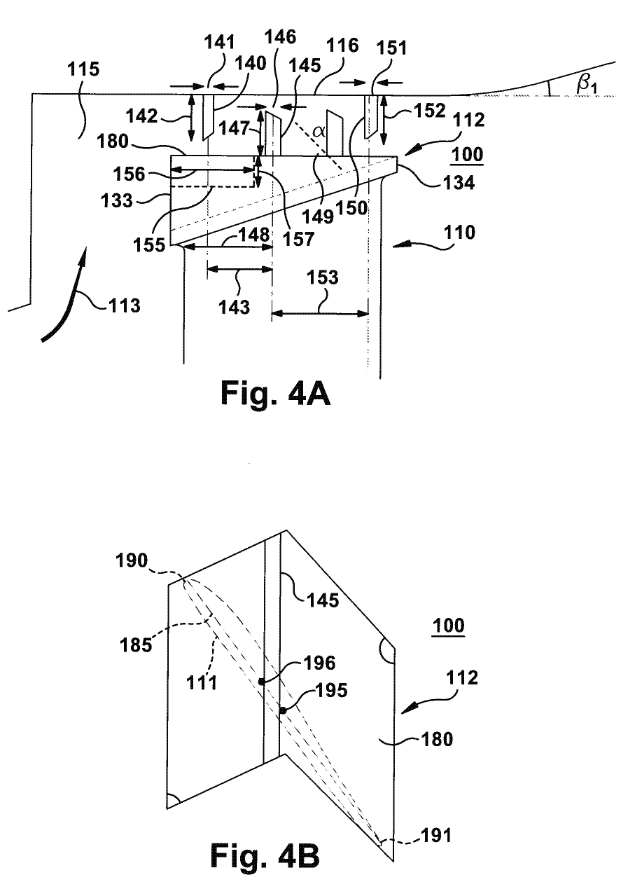

FIG. 3 illustrates an embodiment of a rotor blade component of the inventive tip clearance control mechanism for a stage of a low pressure turbine. The rotor blade 110 includes a sloped rotor blade shroud 112 that provides a sloped pressure side top surface 120 of the blade shroud and a relatively flat suction side top surface 121. The blade shroud 112 may be mounted to an airfoil 111 of a blade 110 for a turbine engine. The airfoil 110 may include a root 130, a tip 131, a leading edge 190, a trailing edge 191, a pressure side 133 and a suction side 134. A dovetail arrangement 135 in the root section 130 engages the airfoil 111 to the rotor wheel of the turbine engine (not shown). The blade shroud 112 may be formed integral with the airfoil 111 at the tip end 131. The rotor blade shroud 112 includes a root tooth 145 positioned with respect to an axial chord of the blade (FIG. 4A, 4B).

FIG. 4A illustrates geometric parameters for components of a rotor shroud and casing shroud for an inventive tip clearance control mechanism. Inlet cavity 115 provides a steam inlet path 113 at the tip end of the rotor blade 110. The tip clearance control mechanism 100 includes a rotor tooth 145, a front stator tooth 140 and a rear stator tooth 150. The rotor tooth 145 may have a thickness 146 and a height 147 and a location 148 with respect to an axial chord line of the blade airfoil as shown in FIG. 4B. The front stator tooth 140 may have a thickness 141 and a height 142 and an axial position 143 relative to the relative to the rotor tooth 145. The rear stator tooth 150 may have a thickness 151 and a height 152 and an axial position 153 relative to the relative to the rotor tooth 145. Teeth on the rotor shroud 112 and the casing shroud 116 may include an angular forward/aft orientation α 149 relative to a radial direction. The arrangement may further include a step 155 disposed at a distance 156 from the pressure side of the rotor shroud sidewall with a step height 157 below the remaining top surface of the rotor shroud.

FIG. 4B illustrates a top view of a top surface 180 of a rotor shroud 112 for a large rotor blade 110 of a low pressure steam turbine. A top view of the airfoil 111 for the rotor blade and an axial chord 185 of the airfoil are shown in phantom. The axial chord 185 traverses between the leading edge 190 and trailing edge 191 of the rotor blade. Location of the rotor tooth 145 may be designated with respect to the percentage distance between the leading edge and trailing edge (e.g. 50% chord length 195, 40% chord length 196).

According to an embodiment of the present invention, a rotary machine tip clearance control mechanism 200 is provided for a stage of a low pressure turbine. The stage may be a final stage of the low pressure turbine. Further, the stage may be a stage at either end of a double-flow low pressure steam turbine. The rotary machine tip clearance control mechanism may provide a rotor blade including an airfoil with a rotor blade shroud disposed on an outer radial tip of the airfoil. A rotor tooth may project radially outward on the rotor blade shroud. The rotor tooth may be generally centered with respect to an axis chord of the airfoil. Further, a casing shroud may be disposed radially outward from the rotor blade shroud. A front stator tooth on the casing shroud, the front stator tooth projecting inward radially and being disposed axially forward relative to the rotor tooth. An aft stator tooth may be provided on the casing shroud, the aft stator tooth projecting inward radially and being disposed aft relative to the rotor tooth. A clearance area is formed between the rotor blade shroud and the casing shroud. The clearance area is adapted to limit leakage flow and increase stage efficiency.

The rotor tooth may be arranged at about 40% to 50% of axial chord length for the airfoil of the blade. Preferentially, the rotor tooth may be set at about 50% of the axial chord length. The rotor tooth height may range from about 0.19 inch to about 0.35 inch. Preferentially, the rotor tooth height may be set at about 0.35 inch. The rotor tooth thickness may be about 0.13 inch. The front stator tooth may be disposed forward from the from the rotor tooth axis by about 0.6 inch to about 0.825 inch. Preferentially the front stator tooth may be located at about 0.8 inch forward from the rotor tooth axis. The front stator tooth height may be sized at about 0.3 inch to about 0.8 inch. The front stator tooth height may be preferentially sized at about 0.6 inch. The aft stator tooth may be disposed about 0.3 inch to about 1.2 inch aft of the rotor tooth axis. The aft stator tooth may preferentially be located about 0.8 inch aft of the rotor tooth. The aft stator tooth may include a height of about 0.2 inch.

The top surface 180 of the shroud may be sloped radially outward between the pressure side of the sidewall for the rotor blade shroud and the rotor tooth. The top surface 180 on the suction side may be essentially flat. In the first embodiment a step rising about 0.16 inch in the top surface of the shroud aft of the pressure side of the shroud sidewall by about 1.02 inch may be provided. In a preferred arrangement, no step in the rotor blade shroud top surface is provided.

Further, the tooth for the front stator tooth, the rotor tooth and the aft stator tooth may include a saw-tooth outer edge wherein the height of the pressure side of the tooth extends further into the clearance area than the height of the suction side of the tooth.

In a further embodiment, the rotor teeth may include a forward or reverse angle with respect to an outward radius from the rotor wheel, however the preferred embodiment provides for rotor teeth projecting radially outward from the rotor blade shroud.

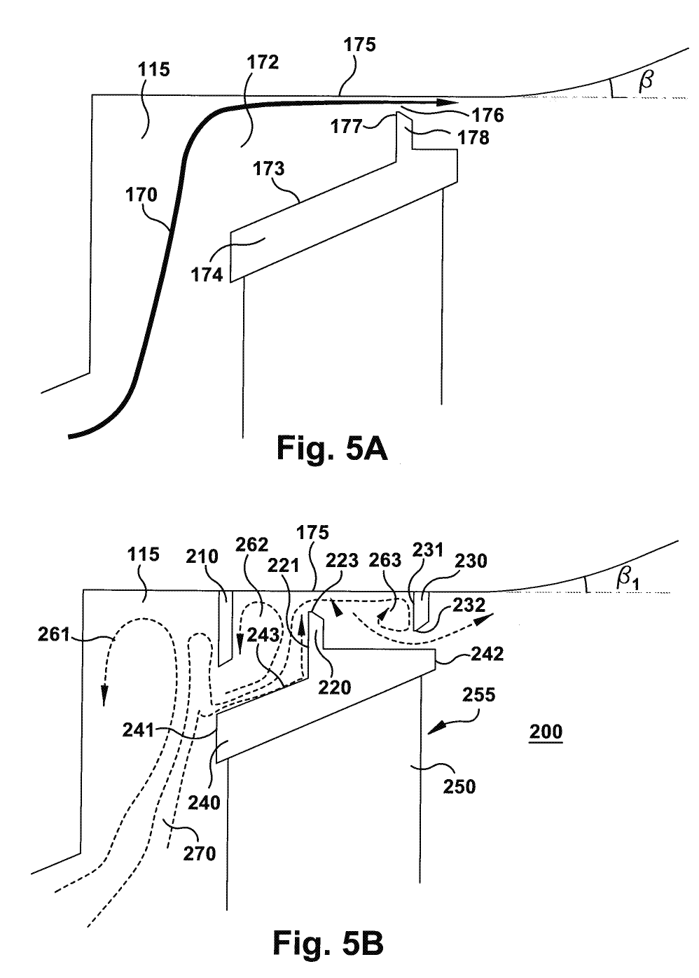

FIG. 5A illustrates leakage flow past a single conventional rotor tooth disposed at a typical location on an aft end of a rotor blade shroud. Tip leakage flow 170 from inlet cavity 115 enters the broad clearance space 172 between a top surface 173 of a baseline rotor blade shroud 174 and casing shroud 175. Leakage flow 170 is restricted only by the one clearance space 176 between the tip 177 of the rotor tooth 178 and the casing shroud 175.

FIG. 5B illustrates leakage flow for the preferred embodiment of the tip clearance control mechanism 200. The clearance mechanism 200 includes a front stator tooth 210 positioned on the casing shroud 175 close to a forward end 241 of the rotor blade shroud 240, a rotor tooth 220 generally centered with respect to the axial chord 185 (FIG. 4B) on the rotor blade shroud, and an aft stator tooth 230 generally disposed proximate to an aft end 242 of the rotor blade shroud. Specific positioning for a preferred embodiment has been described above with respect to the parameters of FIGS. 4A and 4B.

As the flow comes into rotating blade region, a portion of flow enters the cavity 115 and tries to pass through clearance region between the rotor blade shroud 240 and the casing shroud 175. With the presence of front stator tooth 210 there is formation of a first vortex 261 in the inlet cavity 115, diverting some of the leakage flow 270. The forward location of the front stator tooth 210 also encourages the leakage flow 270 downward onto the top surface 243 of the rotor blade shroud 240. This leakage flow 270 then passes to the forward face 221 of the rotor tooth 220, where it moves upwards and forms the second vortex 262 between the rotor blade shroud 240 and the casing shroud 175. This second vortex 262 makes the leakage flow to be “hard-pressed” on to the forward face 221 of the rotor tooth 220 and forces the high-speed flow to take a sharp turn over the rotor tooth edge 223. Since flow is taking a sharp turn over the controlling gap, the effective flow area reduces resulting in less leakage over the rotor tooth 220. Similarly, the leakage flow 170 passing over the rotor tooth edge is urged against the forward edge 231 of the aft stator tooth 230, thereby being forced inward radially and creating a third vortex 263. The third vortex 263 forces the tip leakage flow against the forward face of the aft stator tooth, making passage over the sharp edge 232 of the aft stator tooth more difficult and further limiting leakage flow.

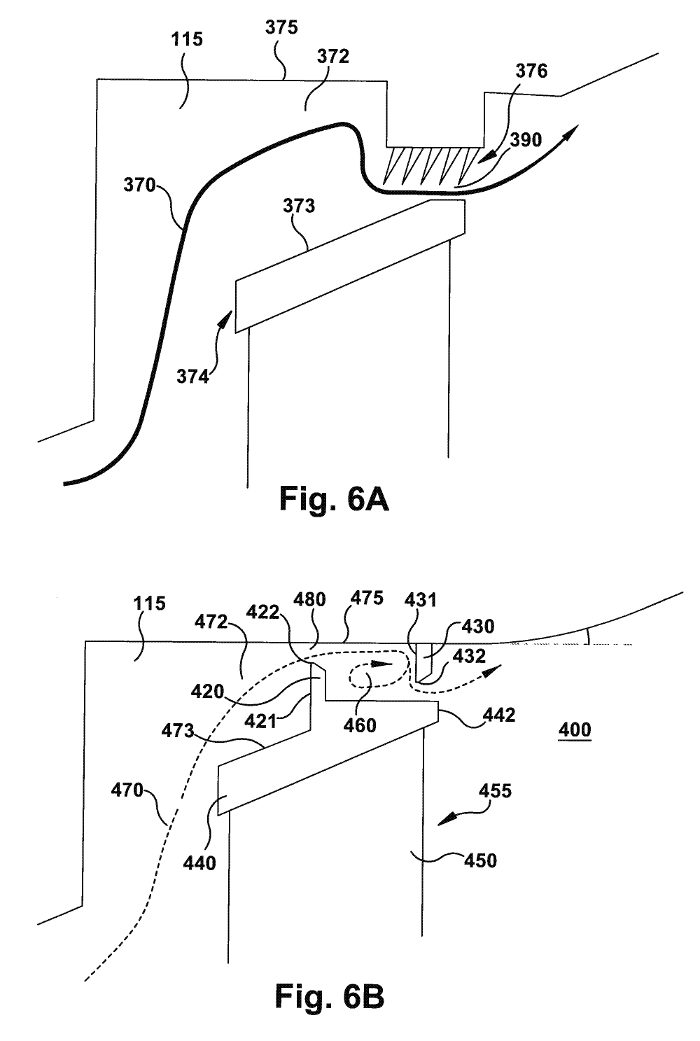

FIG. 6A illustrates leakage flow past a single conventional rotor tooth disposed at a typical location on an aft end of a rotor blade shroud for a next-to-last low pressure turbine blade. A baseline clearance mechanism provides a sloped rotor blade shroud 374 without teeth. Multiple knife-edges 376 project from a casing shroud 375. Leakage flow 370 from inlet cavity 115 enters the broad clearance space 372 between a top surface 373 of a baseline rotor blade shroud 374 and casing shroud 375. Leakage flow 370 is restricted only by the clearance space 372 between the top surface 373 of the rotor blade shroud 375 and the knife edges 376.

FIG. 6B illustrates leakage flow for a preferred embodiment of the clearance mechanism for a next-to-last stage of a low pressure turbine. The clearance mechanism 400 includes a rotor tooth 420 generally centered with respect to the axial chord (FIGS. 4A and 4B) on the rotor blade shroud 440, and an aft stator tooth 440 generally disposed proximate to an aft end 442 of the rotor blade shroud. Specific positioning for a preferred embodiment has been described above with respect to FIGS. 4A and 4B.

As the flow comes into rotating blade region, a portion of flow enters the cavity and tries to pass through region 472 between the top surface 473 of rotor blade shroud 440 and casing shroud 475. The leakage flow 470 then flow past the forward face 421 of the rotor tooth 420 and through restricted clearance 480 between tip 422 of the rotor tooth and the casing shroud 475. The leakage flow 470 passing over the rotor tooth edge 422 is urged against the forward face 431 of the aft stator tooth 430, thereby being forced inward radially and creating a vortex 460. The vortex 460 further forces the leakage flow 470 against the forward face 431 of the aft stator tooth 430, making passage over the sharp edge 432 of the aft stator tooth 430 more difficult and further limiting the tip leakage flow.

Tip leakage flow is one of the major loss sources in a low pressure turbine. A reduction of tip leakage flow reduction may lead directly proportional to turbine performance gain. The inventive clearance mechanism reduces the tip clearance flow by 50% over prior art base case. The inventive tip clearance mechanism leads to an improvement of about 0.5% in final stage efficiency and 0.6% in penultimate stage efficiency, resulting in an improvement of about 0.25% overall efficiency improvement for the low pressure turbine.

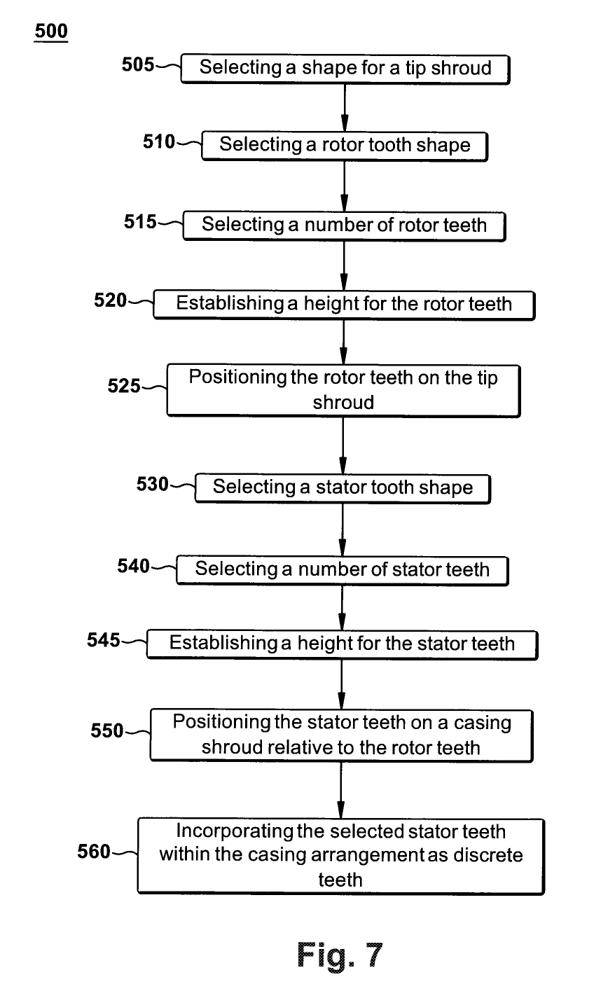

In a further aspect of the present invention a method is provided for a tip clearance control mechanism for a rotor blade of a low pressure steam turbine between a tip shroud of a rotor blade and a casing shroud. FIG. 7 illustrates a flowchart for the method 500 for forming a clearance mechanism for the rotor blade of low pressure steam turbine. The method includes selecting a shape for a tip shroud in step 505; selecting a rotor tooth shape in step 510; selecting a number of rotor teeth in step 515; selecting a stator tooth shape in step 530; and selecting a number of stator teeth in 540.

The method may further include step 520 for establishing the rotor teeth height step 525 locating the rotor teeth on the rotor tip shroud. The method may also further include the step 545 for sizing the height of the stator teeth and step 550 for locating the stator teeth on the stator shroud. The method may further include, in step 560, forming at least one stator tooth as an integral part of an inner wall for the casing for the rotary machine.

The method for selecting a shape for a tip shroud may further include selecting a shape from one of a sloped upstream top surface and a level downstream top surface, a sloped upsteam top surface and a level downsteam top surface with a step therebetween; and a sloped upsteam top surface and a sloped downsteam top surface.

The step of selecting a rotor tooth shape may include: selecting a rotor tooth shape from one of an angled rotor tooth and a normal rotor tooth relative to the top surface of the rotor shroud. The step of selecting a rotor tooth shape may include selecting an arrangement with one rotor tooth or two rotor teeth.

The step of selecting a stator tooth shape may include selecting a stator tooth shape from one of an angled stator tooth, a normal stator tooth, a compound stator tooth with one of a tapered outer end extending in one of an upstream and a downsteam orientation, and a normal stator tooth with an outer end tapering to one of an edge and one of a top surface.

While various embodiments are described herein, it will be appreciated from the specification that various combinations of elements, variations or improvements therein may be made, and are within the scope of the invention.

1. A rotary machine tip clearance control mechanism for a stage of a low pressure steam turbine, the mechanism comprising:
a rotor blade including an airfoil with a rotor blade shroud disposed on an outer radial tip of the airfoil;
a rotor tooth projecting radially outward on the rotor blade shroud, the rotor tooth being generally centered with respect to a chord of the airfoil;
a casing of a rotary machine including a shroud disposed radially outward from the rotor blade shroud;
at least one stator tooth disposed on the casing shroud projecting inward radially; and
a clearance area being formed between the rotor blade and the casing shroud, the clearance area being adapted to limit leakage flow and increase stage efficiency.

2. The rotary machine tip clearance control mechanism according to claim 1, wherein the rotor tooth is disposed in a range of about 40% to about 50% of an airfoil chord length.

3. The rotary machine tip clearance control mechanism according to claim 2, wherein the rotor tooth height comprises about 0.19 inch to about 0.35 inch.

4. The rotary machine tip clearance control mechanism according to claim 3, wherein the at least one stator tooth includes at least one of a front stator tooth disposed forward relative to a rotor tooth axis in a range of about 0.6 inch to about 0.825 inch and an aft stator tooth disposed aft relative to the rotor tooth axis in a range of about 0.5 inch to about to about 1.0 inch.

5. The rotary machine tip clearance control mechanism according to claim 1, wherein the rotor blade shroud comprises an outward sloped upper surface on a pressure side of the rotor tooth and a substantially flat upper surface on a suction side of the rotor tooth.

6. The rotary machine tip clearance control mechanism according to claim 1 wherein:
the rotor blade comprises a last stage rotor blade for the low pressure turbine;
the rotor tooth is disposed at about 50% of airfoil chord length;
the rotor tooth height comprises about 0.35 inch;
the at least one stator tooth includes a front stator tooth disposed forward from rotor tooth axis by about 0.8 inch and aft stator tooth disposed aft from the rotor tooth axis by about 0.8 inch;
the front stator tooth height comprises about 0.6 inch and the aft stator tooth height comprises about 0.2 inch; and
the rotor blade shroud comprises a sloped upper surface on a pressure side of the rotor tooth and a substantially flat upper surface on a suction side of the rotor tooth.

7. The rotary machine tip clearance control mechanism according to claim 3, wherein the rotor tooth is disposed at about 50% of airfoil chord length.

8. The rotary machine tip clearance control mechanism according to claim 7, wherein at least one stator tooth comprises at least one of a front stator tooth disposed forward by about 0.5 inch to about 0.7 inch relative to the rotor tooth and an aft stator tooth disposed aft from the rotor tooth axis in a range of about 1.1 inch to about to about 1.5 inch.

9. The rotary machine tip clearance control mechanism according to claim 7, wherein the aft stator tooth height comprises about 0.2 inch.

10. The rotary machine tip clearance control mechanism according to claim 12, wherein the rotor blade shroud comprises an outward sloped upper surface on a pressure side of the rotor tooth and an outward sloped upper surface on a suction side of the rotor tooth.

11. The rotary machine tip clearance control mechanism according to claim 3, wherein:
the rotor blade comprises a penultimate stage rotor blade for the low pressure turbine;
the rotor tooth is disposed at about 50% of airfoil chord length;
the rotor tooth height comprises about 0.35 inch;
the aft stator tooth is diaposed about 0.95 inch aft of the rotor tooth axis;
the aft stator tooth height comprises about 0.2 inch; and
the rotor blade shroud comprises a sloped upper surface on a pressure side of the rotor tooth and a sloped upper surface on a suction side of the rotor tooth.

12. The rotary machine tip clearance control mechanism according to claim 1, wherein the at least one stator tooth is formed as an integral part of the casing for the rotary machine.

13. A method for tip clearance control on a rotary machine adapted for improving stage efficiency with reduced tip leakage, the method comprising:
selecting a shape for a tip shroud;
selecting a rotor tooth shape;
selecting a number of rotor teeth;
selecting a stator tooth shape; and
selecting a number of stator teeth.

14. The method according to claim 13, the step of selecting a shape for a tip shroud comprising:
selecting a shape from one of a sloped upstream top surface and a level downstream top surface, a sloped upsteam top surface and a level downsteam top surface with a step therebetween; and a sloped upsteam top surface and a sloped downsteam top surface.

15. The method according to claim 13, the step of selecting a rotor tooth shape comprising:
selecting a rotor tooth shape from one of an angled rotor tooth and a normal rotor tooth relative to the top surface of the rotor shroud.

16. The method according to claim 13, the step of selecting a rotor tooth shape comprising:
selecting an arrangement with one rotor tooth or two rotor teeth.

17. The method according to claim 13, the step of selecting a stator tooth shape comprising:
selecting a stator tooth shape from one of an angled stator tooth, a normal stator tooth, a compound stator tooth with one of a tapered outer end extending in one of an upstream and a downsteam orientation, and a normal stator tooth with an outer end tapering to one of an edge and one of a top surface.

18. The method according to claim 13, further comprising:
sizing the height of the stator teeth.

19. The method according to claim 13, further comprising:
locating the stator teeth on the stator shroud.

20. The method according to claim 13, further comprising:
locating the rotor teeth on the tip shroud.

21. The method according to claim 13, further comprising:
establishing the rotor teeth height.

22. The method according to claim 13, further comprising:
forming at least one stator tooth as an integral part of an inner wall for the casing for the rotary machine.
